(19) United States
(12) Patent Application Publication
(10) Pub. No.: US 2013/0233469 A1
(43) Pub. Date: Sep. 12, 2013

(54) METHOD FOR PRODUCING CAPACITIVE TOUCH PANELS

(71) Applicant: AVCT OPTICAL ELECTRONIC CO., LTD., Chung Li City (TW)

(72) Inventors: JYR-DWO LEE, Chung Li City (TW); SHIH-LIANG CHOU, Chung Li City (TW); HSUEH- CHIH CHIANG, Chung Li City (TW); WEN-TSUN MA, Chung Li City (TW)

(73) Assignee: avct Opitcal Electronic Co., Ltd, Chung Li City (TW)

(21) Appl. No.: 13/870,257

(22) Filed: Apr. 25, 2013

Related U.S. Application Data
(63) Continuation-in-part of application No. 12/847,327, filed on Jul. 30, 2010.

(30) Foreign Application Priority Data
Mar. 26, 2010 (TW) 099109075

(51) Int. Cl. G06F 3/044

(52) U.S. Cl. CPC G06F 3/044
USPC 156/150; 156/256

(57) ABSTRACT

The invention discloses a method for producing capacitive touch panels. The method comprises providing a plastic substrate including multiple predetermined regions; forming an icon or artwork layer on the plastic substrate; forming a first sensing layer on the icon or artwork layer; laminating a flexible transparent film onto the plastic substrate; forming a second sensing layer on the flexible transparent film; cutting the predetermined regions from the plastic substrate to become individual capacitive touch panels; and subjecting the capacitive touch panels to bonding, so that the peripheral wires of the respective capacitive touch panels are connected to a flexible printed circuit board.

### CROSS-REFERENCE TO RELATED APPLICATION

This application is a continuation-in-part of U.S. Ser. No. 12/847,327 filed on Jul. 30, 2010, the disclosure of which is incorporated herein by reference in its entirety.

### BACKGROUND OF THE INVENTION

1.l Field of the Invention

The present invention relates to a method for producing capacitive touch panels and, more particularly, to a method for producing capacitive touch panels on large-scale with high productivity and low manufacture cost.

2. Description of the Prior Art

There are some common types of touch panel devices, namely, the resistive-type, capacitive-type, surface acoustic wave-type, optical- (infrared-) type touch control devices and so on. Among these, the most commonly used are the resistive-type touch panels, followed by the capacitive touch panels. The capacitive touch panels have the advantages of waterproofing and scratch-proofing, and they have high light transmittance and a broad range of temperature tolerance. Therefore, the capacitive touch panels come at a high price. With the advancement of technology, however, the capacitive touch panels are beginning to gain a share in the market of small monitors.

Typically, a conventional capacitive touch panel comprises a bottom transparent substrate, a top transparent substrate and a transparent cover lens. A top indium-tin oxide layer and a bottom indium-tin oxide layer are formed on the surfaces of the top and the bottom transparent substrates, respectively.

Afterwards, an optical clear adhesive (OCA) is applied to bind the top transparent substrate and the bottom transparent substrate, so that a layer of OCA is sandwiched between the top indium-tin oxide layer and the bottom indium-tin oxide layer facing each other. The transparent cover lens is bound to the top transparent substrate by a layer of OCA, so as to complete the assembly of the transparent capacitive touch panel. The transparent cover lens serves to protect the top and the bottom transparent substrates.

However, the conventional transparent capacitive touch panel is too thick and heavy to meet the design trend of light-weight and slimness, as the top and bottom transparent substrates and the transparent cover lens are generally made of glass material. In addition, the conventional manufacturing methods can only produce a single touch panel product at a time and, thus, has limited productivity. There is a need for a method for producing capacitive touch panels at elevated productivity and reduced manufacture cost.

### SUMMARY OF THE INVENTION

An object of the invention is to provide to a method for producing capacitive touch panels and, more particularly, to a method for producing capacitive touch panels on large-scale with high productivity and low manufacture cost.

In order to achieve the object described above, the method according to the invention comprises the steps of:

providing a plastic substrate having a top surface and a bottom surface, wherein the plastic substrate includes a plurality of predetermined regions, each of which is to be fabricated into a capacitive touch panel;

forming an icon or artwork layer on the bottom surface of the plastic substrate, wherein the icon or artwork layer comprises a plurality of icon or artwork units, each being disposed on the periphery of a corresponding one of the predetermined regions;

forming a first sensing layer on the icon or artwork layer, wherein the first sensing layer comprises a plurality of first sensing series and a plurality of first peripheral wires electrically connected to the first sensing series, the first sensing series being formed on an area of the predetermined regions that is not covered by the icon or artwork units, and the first peripheral wires being disposed on the icon or artwork units in such a manner that they are shielded from outside by the icon or artwork units;

laminating a flexible transparent film onto the plastic substrate formed with the first sensing layer, with the flexible transparent film facing the bottom surface of the plastic substrate;

forming a second sensing layer on the flexible transparent film, wherein the second sensing layer comprises a plurality of second sensing series and a plurality of second peripheral wires electrically connected to the second sensing series, the second sensing series being formed on an area of the flexible transparent film that is not covered by the icon or artwork units, so that the respective first sensing series and the respective second sensing series are arranged in an alternate manner, and the second peripheral wires being formed on the flexible transparent film in such a manner that they are shielded from outside by the icon or artwork units;

cutting the predetermined regions from the plastic substrate to become individual capacitive touch panels; and

subjecting the capacitive touch panels to bonding, so that the first and second peripheral wires of the respective capacitive touch panels are connected to a flexible printed circuit board.

The invention is superior to the prior art methods in view of the following aspects:

1. The substrate used in the invention is made of plastic material and, thus, the capacitive touch panel produced by the invention is slim enough to meet the trend of light-weight and compactness for electronic products.

2. The invention allows production of multiple capacitive touch panels in a single run of operation, thereby greatly enhancing the productivity and lowering the manufacture cost.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a flowchart of the method for producing capacitive touch panels according to an embodiment of the invention;

FIG. 2 is a schematic diagram of the plastic substrate used in an embodiment of the invention;

FIG. 3 is a schematic diagram showing the formation of the icon or artwork layer on the plastic substrate;

FIG. 4 is a schematic diagram showing the predetermined region and the icon or artwork layer;

FIG. 5 is a schematic cross-sectional diagram showing the formation of the first sensing layer;

FIG. 6 is a schematic cross-sectional diagram showing the finishing of the first sensing layer;

FIG. 7 is a schematic cross-sectional diagram showing the lamination of the flexible transparent film onto the plastic substrate;

FIG. 8 is a schematic cross-sectional diagram showing the formation of the second sensing layer;

FIG. 9 is a schematic cross-sectional diagram showing the finishing of the second sensing layer; and

FIG. 10 is a schematic cross-sectional view of a capacitive touch panel obtained after the cutting step.

### DETAILED DESCRIPTION OF THE PREFERRED EMBODIMENTS

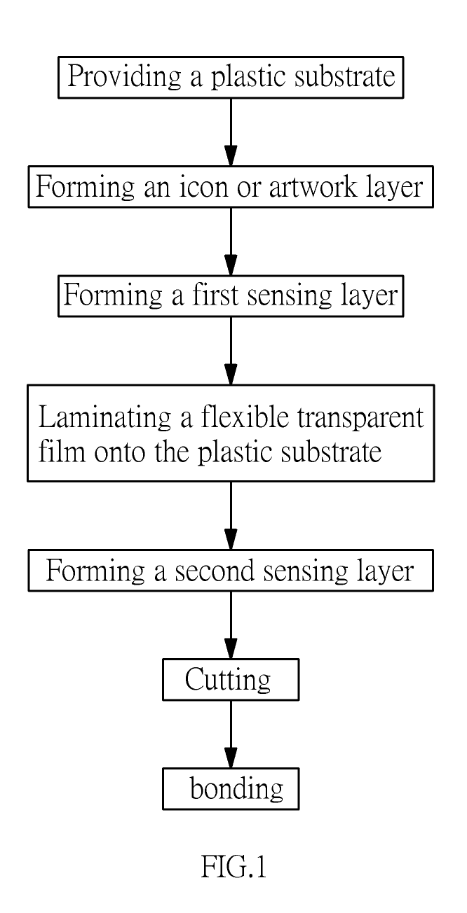

According to the flowchart shown in FIG. 1, the invented method for producing capacitive touch panels comprises the following steps.

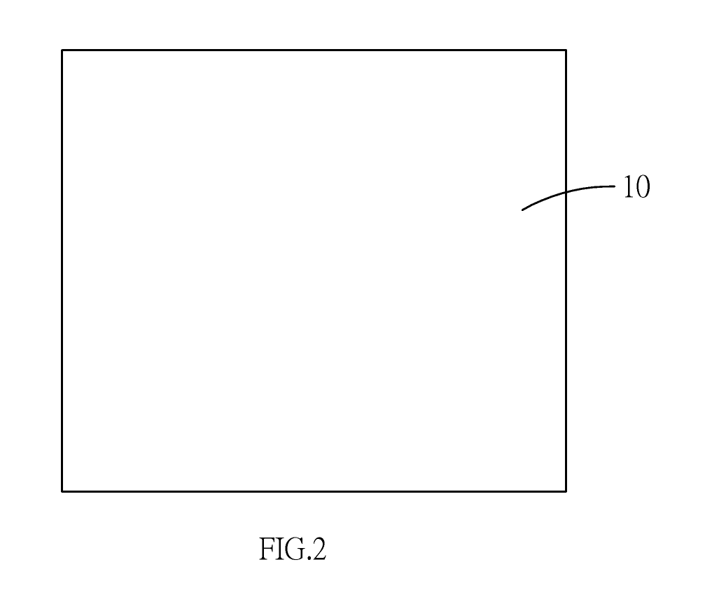

A plastic substrate 10 is provided. As shown in FIG. 2, the plastic substrate 10 includes a plurality of predetermined regions 11, optionally arranged in a matrix manner on the plastic substrate 10. Each of the predetermined regions is to be fabricated into a capacitive touch panel.

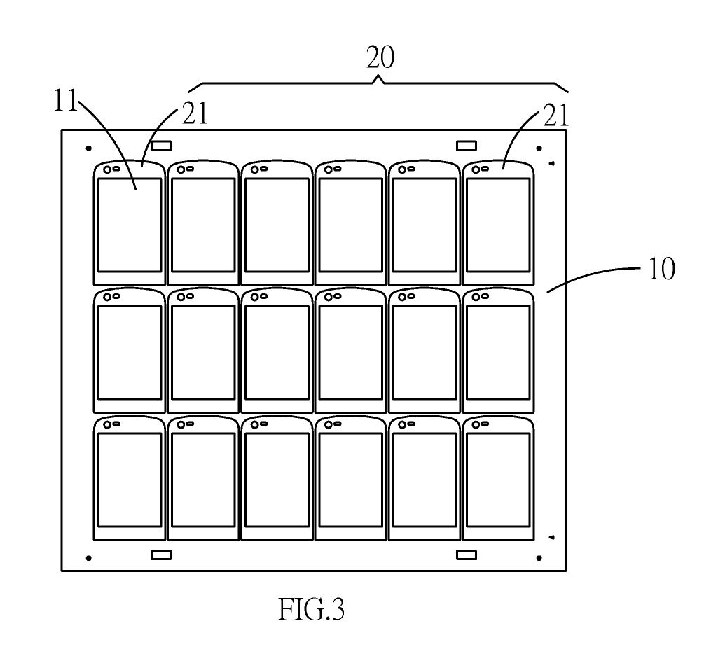

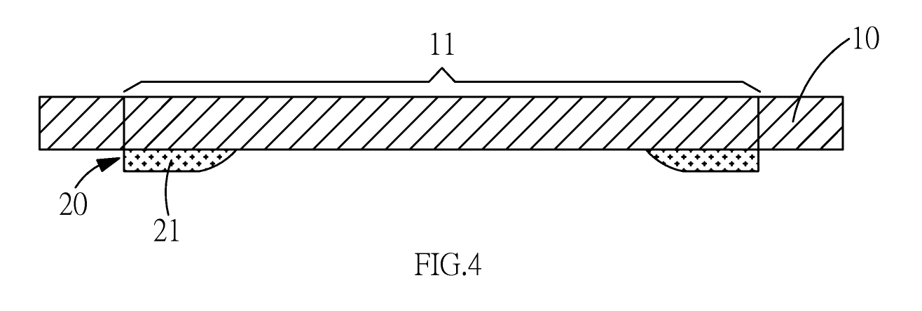

Then, an icon or artwork layer 20 is formed. As shown in FIGS. 3 and 4, the icon or artwork layer 20 is formed on the bottom surface of the plastic substrate 10 using a screen-printing, ink-jet printing or photolithographic process. The icon or artwork layer 20 comprises a plurality of icon or artwork units 21, each being disposed on the periphery of a corresponding one of the predetermined regions 11. The inner periphery of the icon or artwork unit 21 is not perpendicular to the adjacent line of the corresponding predetermined region 11, so that the formation of the subsequent structures can be complete. In the case of using a screen-printing process to form the icon or artwork units 21 whose outer surfaces meet the corresponding predetermined regions 11 at a non-perpendicular angle, the following parameters may by way of example be used in the process: an ink viscosity of 10˜30 dPa·s, the screen conditioned at 50˜400 mesh tetron screen, and the tension at minimum 15 Newton force. The icon or artwork layer 20 thus formed has a film thickness of about 2˜15 μm.

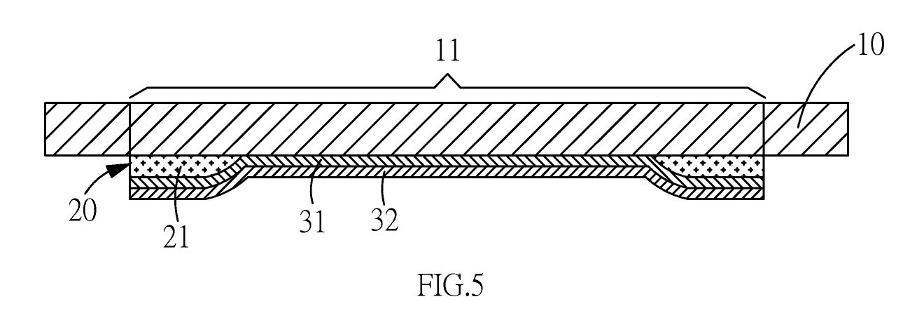

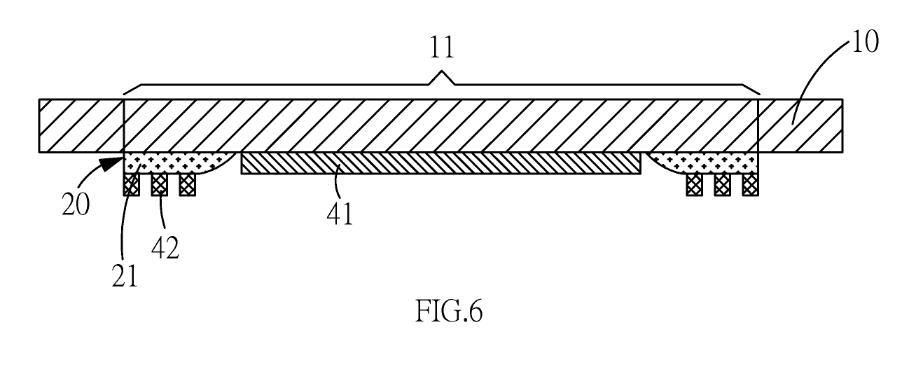

Then, a first sensing layer is formed. As shown in FIG. 5, the plastic substrate 10 and the icon or artwork layer 20 are coated, in sequence, with a first transparent conductive layer 31 and a first metal layer 32. The first transparent conductive layer 31 and the first metal layer 32 are patterned (using, for example, a photolithographic process, a laser patterning process or a printing process) to form a plurality of first sensing series 41 and a plurality of first peripheral wires 42 electrically connected to the first sensing series 41. As shown in FIG. 6, the first sensing series 41 are formed on an area of the predetermined regions 11 that is not covered by the icon or artwork units 21, and the first peripheral wires 42 are formed on the icon or artwork units 21 in such a manner that they are shielded from outside by the icon or artwork units 21. The first transparent conductive layer 31 is made of transparent conductive material, such as ITO, with a thickness of about 10-100 nm. The first transparent conductive layer 31 is preferably formed by using vacuum DC and RF magnetron sputtering deposition technique. Optionally, an alternative method, such as layer-by-layer sputtering, spray pyrolysis, pulsed laser deposition, arc discharge ion plating, reactive evaporation, ion beam sputtering, or chemical vapor deposition (CVD) etc. can be used. Considering the temperature tolerance of the plastic substrate 10 used in the method, the coating of the first transparent conductive layer 31 and the first metal layer 32 is preferably carried out at a temperature of less than 100° C.

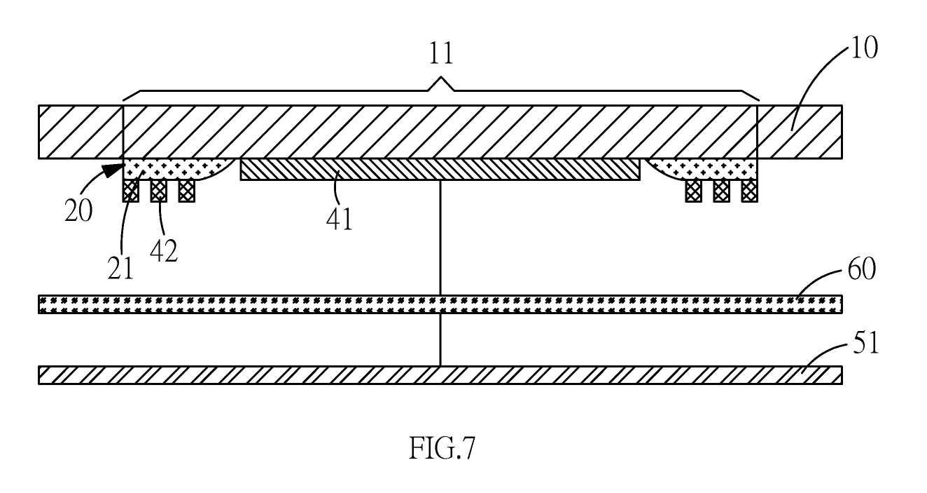

A flexible transparent film 51 is provided. As shown in FIG. 7, by using a layer of OCA 60, the flexible transparent film 51 is laminated onto the plastic substrate 10 formed with the first sensing layer, in such a manner that the flexible transparent film 51 faces the bottom surface of the plastic substrate 10.

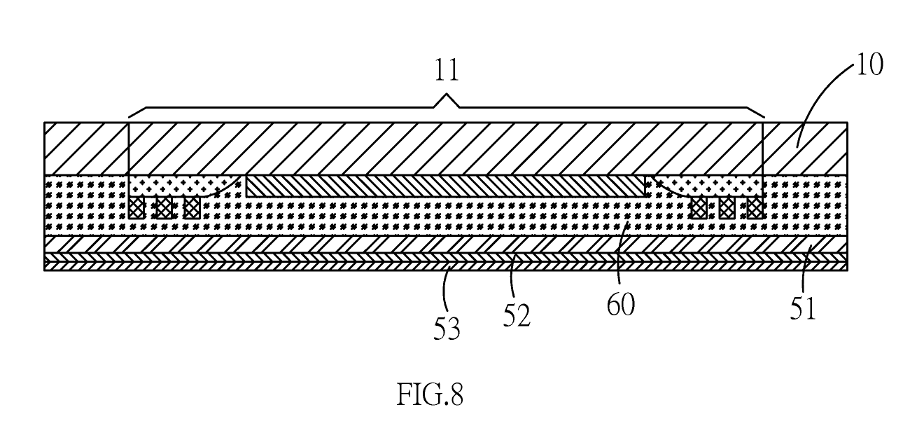

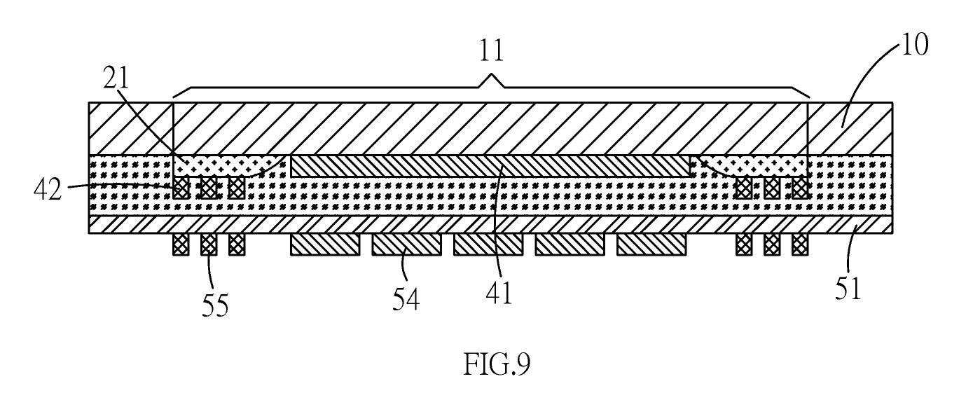

A second sensing layer is then formed. As shown in FIG. 8, the flexible transparent film 51 is coated, in sequence, with a second transparent conductive layer 52 and a second metal layer 53. The second transparent conductive layer 52 and the second metal layer 53 are patterned (using, for example, a photolithographic process, a laser patterning process or a printing process) to form a plurality of second sensing series 54 and a plurality of second peripheral wires 55 electrically connected to the second sensing series 54. As shown in FIG. 9, the second sensing series 54 are formed on an area of the flexible transparent film 51 that is not covered by the icon or artwork units 21, so that the respective first sensing series 41 and the respective second sensing series 54 are arranged in an alternate manner. The second peripheral wires 55 are formed on the flexible transparent film 51 in such a manner that they are shielded from outside by the icon or artwork units 21. The second transparent conductive layer 52 is made of transparent conductive material, such as ITO, with a thickness of about 10-100 nm. The second transparent conductive layer 52 is preferably formed by using vacuum DC and RF magnetron sputtering deposition technique. Optionally, an alternative method, such as layer-by-layer sputtering, spray pyrolysis, pulsed laser deposition, arc discharge ion plating, reactive evaporation, ion beam sputtering, or chemical vapor deposition (CVD) etc. can be used. Considering the temperature tolerance of the flexible transparent film 51 used in the method, the coating of the second sensing series 54 and the second peripheral wires 55 is preferably carried out at a temperature of less than 100° C.

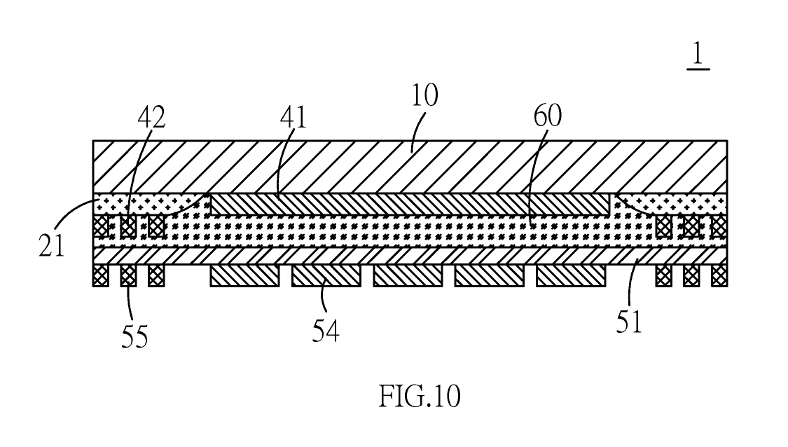

Afterwards, the respective predetermined regions 11 are cut from the plastic substrate 10 to become individual capacitive touch panels 1, as shown in FIG. 10. The cutting step can be carried out on a CNC cutting machine, a contour cutting machine, or a laser cutting machine. Considering the mechanical strength of the plastic substrate 10 used in the method, the plastic substrate 10 is preferably subjected to air-cooled dry cutting, whereby it is cut by a synthetic diamond-coated tungsten carbide rotary blade operated at a rotary speed of 10,00˜30,000 rpm, preferably about 25,000 rpm, and a forward speed of 1000˜5000 mm/min, preferably about 3000 mm/min.

After cutting, the obtained capacitive touch panels are subjected to a bonding process, in which the peripheral wires of the respective capacitive touch panels 1 are connected to a flexible printed circuit board (not shown), thereby producing finished capacitive touch panel products. It should be noted that the cutting step and the bonding step shown in FIG. 1 can be interchanged. That is to say, the cutting step may be carried out either prior to or subsequent to the bonding step. Considering the temperature tolerance of the plastic substrate 10 used in the method, the bonding is preferably carried out at a relatively low temperature, more preferably less than 120° C., and a pressure of 1˜2 bar, more preferably about 1.5 bar, for a time period of 10˜40 seconds, more preferably about 25 seconds.

In addition, the flexible transparent film 51 may be perforated before being laminated onto the plastic substrate 10, so that the first peripheral wires 42 are exposed after the lamination for connection to a flexible printed board during the bonding step. The perforation of the flexible transparent film 51 may be carried out using a CNC cutting machine, a contour cutting machine, or a laser cutting machine.

Furthermore, an optical film may be formed before and/or after the formation of the first sensing layer, so that the first sensing layer is coated on one or both of its surfaces with the optical film. The optical film formed on the first sensing layer serves to minimize the adverse effect of the etched pattern of the first sensing layer on the user's visual perception. The optical film may be formed to have a thickness of less than 200 nm by a sputtering, spraying or coating process. It is apparent to those skilled in the art that the sensing layer may be additionally coated with a second optical film. An additional optical film, such as an anti-glare coating or an anti-reflection coating, may be formed subsequent to the formation of the second sensing layer, as a means to enhance the overall transparency.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit of the invention and the scope thereof as defined in the appended claims.

What is claimed is:

1. A method for producing capacitive touch panels, comprising the steps of:
providing a plastic substrate having a top surface and a bottom surface, wherein the plastic substrate includes a plurality of predetermined regions, each of which is to be fabricated into a capacitive touch panel;
forming an icon or artwork layer on the bottom surface of the plastic substrate, wherein the icon or artwork layer comprises a plurality of icon or artwork units, each being disposed on the periphery of a corresponding one of the predetermined regions;
forming a first sensing layer on the icon or artwork layer, wherein the first sensing layer comprises a plurality of first sensing series and a plurality of first peripheral wires electrically connected to the first sensing series, the first sensing series being formed on an area of the predetermined regions that is not covered by the icon or artwork units, and the first peripheral wires being disposed on the icon or artwork units in such a manner that they are shielded from outside by the icon or artwork units;
laminating a flexible transparent film onto the plastic substrate formed with the first sensing layer, with the flexible transparent film facing the bottom surface of the plastic substrate;
forming a second sensing layer on the flexible transparent film, wherein the second sensing layer comprises a plurality of second sensing series and a plurality of second peripheral wires electrically connected to the second sensing series, the second sensing series being formed on an area of the flexible transparent film that is not covered by the icon or artwork units, so that the respective first sensing series and the respective second sensing series are arranged in an alternate manner, and the second peripheral wires being formed on the flexible transparent film in such a manner that they are shielded from outside by the icon or artwork units;
cutting the predetermined regions from the plastic substrate to become individual capacitive touch panels; and
subjecting the capacitive touch panels to bonding, so that the first and second peripheral wires of the respective capacitive touch panels are connected to a flexible printed circuit board.

2. The method for producing capacitive touch panels according to claim 1, wherein the bonding of the capacitive touch panels is carried out subsequent to the forming of the second sensing layer and prior to the cutting step.

3. The method for producing capacitive touch panels according to claim 1, wherein the icon or artwork layer is formed using a screen-printing, ink-jet printing or photolithographic process.

4. The method for producing capacitive touch panels according to claim 1, wherein the icon or artwork units each has an inner periphery that meets the corresponding predetermined region at a non-perpendicular angle.

5. The method for producing capacitive touch panels according to claim 1, wherein the forming of the first sensing layer comprises sequentially coating a first transparent conductive layer and a first metal layer on the plastic substrate and the icon or artwork layer, and patterning the first transparent conductive layer and the first metal layer to form the first sensing series and the first peripheral wires electrically connected to the first sensing series.

6. The method for producing capacitive touch panels according to claim 1, wherein the forming of the second sensing layer comprises sequentially coating a second transparent conductive layer and a second metal layer on the flexible transparent film, and patterning the second transparent conductive layer and the second metal layer to form the second sensing series and the second peripheral wires electrically connected to the second sensing series.

7. The method for producing capacitive touch panels according to claim 1, further comprising, before and/or after the forming of the first sensing layer, a step of forming an optical film, so that the first sensing layer is coated on one or both of its surfaces with the optical film.

8. The method for producing capacitive touch panels according to claim 1, further comprising, before laminating the flexible transparent film onto the plastic substrate, a step of perforating the flexible transparent film, so that the first peripheral wires are exposed for connection to a flexible printed board after the laminating.

9. The method for producing capacitive touch panels according to claim 1, wherein the forming of the first and second sensing layers is carried out using sputtering deposition technique at a temperature of less than 100° C.

10. The method for producing capacitive touch panels according to claim 1, wherein the cutting is performed using air-cooled dry cutting.

11. The method for producing capacitive touch panels according to claim 12, wherein the air-cooled dry cutting is carried out using a synthetic diamond-coated tungsten carbide rotary blade.

12. The method for producing capacitive touch panels according to claim 1, wherein the bonding of the capacitive touch panels is carried out at a temperature of less than 120° C.
